(19) United States
(12) Patent Application Publication
(10) Pub. No.: US 2016/0271519 A1
(43) Pub. Date: Sep. 22, 2016

(54) Vacuum Condenser

(71) Applicants: Jayden David HARMAN, San Rafael, CA (US); Peter WOODGATE, Dianella WA (AU); Kimberly PENNEY, Emeryville, CA (US); Bruce WEBSTER, San Rafael, CA (US); Kasra FARSAD, San Jose, CA (US)

(72) Inventors: Jayden David Harman, San Rafael, CA (US); Peter Woodgate, Dianella WA 6059 (AU); Kimberly Penney, Emeryville, CA (US); Bruce Webster, San Rafael, CA (US); Kasra Farsad, San Jose, CA (US)

(21) Appl. No.: 14/888,911

(22) PCT Filed: May 5, 2014
(86) PCT No.: PCT/US14/00082

§ 371 Date: Jan. 14, 2016

Related U.S. Application Data
(60) Provisional application No. 61/854,895, filed on May 3, 2013.

(51) Int. Cl. B01D 5/00; C02F 1/10; B01D 1/14

(52) U.S. Cl. CPC B01D 5/0045; B01D 5/0036; B01D 5/006; B01D 5/0003; B01D 1/14; C02F 1/10; C02F 2301/063

(57) ABSTRACT

A vacuum condenser adapted to reduce pressure in an enclosure containing a secondary liquid and thereby cause the accelerated production of vapor from the secondary liquid by the passage of a primary liquid through the vacuum condenser and whereby the vapor produced is absorbed by the primary liquid within the vacuum condenser by being entrained and condensed within the primary liquid wherein the vacuum condenser is configured to cause the operating temperature of the secondary liquid within the enclosure to maintain a stable minimum temperature for a predetermined substantial rate of production of vapor.

### CROSS-REFERENCE TO RELATED APPLICATIONS

The present application is a national phase application of PCT application PCT/US2014/000082 filed May 5, 2014, which claims the priority benefit of U.S. provisional application No. 61/854,895 filed May 3, 2013, the disclosures of which are incorporated herein by reference.

### FIELD OF THE INVENTION

The present invention relates to a venturi vacuum pump which acts as a vacuum condenser.

### BACKGROUND

Venturi vacuum pumps are well known and commonly used in applications where a gas such as air or a liquid such as water is forced under pressure through a venturi formation thereby providing a reduced pressure in the vicinity of the constricted or throat region of the venturi. The reduced pressure can be communicated by suitable porting for use in various applications. However, to date the commercial use of venturi vacuum pumps has been limited and somewhat specialized.

The publication WO2011/123904 by Harman et. al. discloses a new application for the venturi vacuum pump whereby the vacuum pump is not only used to create a vacuum in an evacuation chamber but also to absorb the vapor boiled from a secondary liquid within the chamber to provide a continuous process for distillation and other purposes. This disclosure is hereby incorporated by reference. The disclosure provides a distillation system whereby vapor is condensed by being absorbed into a primary liquid by being entrained and condensed within it and passed through the venturi to produce the vacuum, and thereby the need for a separate condenser is removed. Such a system provides many advantages as is discussed within the disclosure.

The system proposed in the WO2011/123904 can potentially operate with any venturi vacuum pump that effectively provides a vacuum when an appropriate liquid is passed through it. However, testing has revealed that while this is so at a general sense, when the aim is to produce substantial rate of production of vapor and its absorption, problems arise. An improved venturi was proposed in the basic application but it now has been identified that such a device did not fully address what was required to achieve the operating goals of the Vapor Absorption System. The present invention provides a venturi vacuum pump, hereinafter referred to as a vacuum condenser, specifically adapted for use with a Vapor Absorption System according to WO2011/123904 to take account of not only fluid flows but also of thermodynamic factors. The present device is particularly suitable for use in high power applications where it is desirable to have the temperature of the secondary remain low so that relatively low grade heat sources may be used effectively to provide the latent heat of vaporization.

A more detailed description of the problems that must be addressed and the factors to be considered in providing an optimized vacuum condenser are provided in conjunction with the description of the invention.

### DISCLOSURE OF THE INVENTION

Accordingly the invention resides in a vacuum condenser adapted to reduce pressure in an enclosure containing a secondary liquid and thereby cause the accelerated production of vapor from the secondary liquid by the passage of a primary liquid through the vacuum condenser and whereby the vapor produced is absorbed by the primary liquid within the vacuum condenser by being entrained and condensed within the primary liquid wherein the vacuum condenser is configured to cause the operating temperature of the secondary liquid within the enclosure to maintain a stable minimum temperature for a predetermined substantial rate of production of vapor.

According to a preferred feature of the invention, rate of production of vapor is determined by selecting an energy input level to provide the required latent heat of vaporization to the secondary liquid.

According to a preferred feature of the invention, the vacuum condenser comprises an enclosed body supporting an inlet nozzle, an outlet nozzle and a hot vapor entrance which communicates hot vapor from the enclosure, the inlet nozzle providing a flow path for the primary liquid of reducing cross-section between an inlet nozzle entrance and an inlet nozzle exit, the outlet nozzle providing a flow path for the primary liquid co-aligned with the flow path of the inlet nozzle and having a receiving portion of progressively reducing cross-section between an outlet nozzle entrance and an outlet nozzle minimum region and having an expanding portion between the outlet nozzle minimum region and outlet nozzle exit to thereby provide a venturi profile in conjunction with the inlet nozzle.

According to a preferred feature of the invention, a gap is provided between the inlet nozzle exit and the outlet nozzle entrance.

According to a preferred feature of the invention, the size of the gap is selected to cause the operating temperature of the secondary liquid within the enclosure to maintain a stable minimum temperature.

According to a preferred embodiment, a first pump is provided on the nozzle inlet side of the primary liquid flow path.

According to a preferred embodiment, a second pump is provided on the nozzle outlet side of the primary liquid flow path.

According to a further aspect, the invention resides in a method of optimizing the performance of a vapor condenser as previously described whereby design parameters of the vacuum condenser are repetitively modified and the modified vacuum condenser is tested using the application of a pre-determined power level to the secondary liquid within the enclosure to ascertain whether the temperature and pressure of the modified vacuum condenser are at a minimum relative to previous designs tested.

According to a further aspect, the invention resides in a vapor absorption system comprising an evacuation chamber configured to receive a secondary liquid, the secondary liquid being a mixture to be distilled, the evacuation chamber having a space above the secondary liquid configured to receive vapour evaporated from the secondary liquid, and an evacuation pump associated with the evacuation chamber and adapted in use to provide a reduced pressure within the space to promote vaporisation of the secondary liquid, wherein evacuation pump comprises a vacuum condenser previously described which is operated by a primary liquid flowing through the vacuum condenser.

According to a preferred feature of the invention, the vapor absorption system is provided with a heat transfer and recovery system comprising a heat exchanger adapted to supply heat energy to the secondary liquid to provide the latent heat of vaporization, the heat energy being transferred from heat exchange fluid passing through the heat exchanger, the heat exchange fluid thereafter being conveyed to a secondary fluid heat exchange circuit within a heat pump, the heat pump also receiving primary liquid from the evacuation pump and passing through a primary liquid heat exchange circuit within the heat pump, to transfer the latent heat received by the primary liquid with the evacuation pump to the heat exchange fluid by means of the heat pump and whereafter the heat exchange fluid is re-circulated to the heat exchanger.

According to a preferred feature of the invention, the vapor absorption system is provided with a heat replenishment system to provide additional heat to the heat exchange fluid to compensate for heat dissipated within the system.

A vapor absorption system as claimed in any one of claims 9 to 11 wherein a pump is provided on the outlet side of the evacuation pump.

A vapor absorption system as claimed in any one of claims 9 to 12 wherein the evacuation pump and heat exchanger are combined as an integral unit in the form of a tube shell heat exchanger.

According to a preferred feature of the invention, the primary liquid is kept isolated from the secondary liquid to prevent contamination of the primary liquid by the secondary liquid.

According to a further aspect, the invention resides in a cascade vapor absorption system wherein a plurality of vapour absorption systems as previously decribed are integrally combined so that the latent heat output resulting from the condensation of vapor of a previous system is supplied to a subsequent unit to provide the latent heat of vaporisation for the subsequent unit.

The invention will be more fully understood in the light of the following description of two preferred embodiments.

### BRIEF DESCRIPTION OF THE DRAWINGS

The description is made with reference to the accompanying drawings, of which:

FIG. 1 is a diagrammatic representation of a vapor absorption system according to the prior art;

FIG. 2 is an isometric view of a vacuum condenser according to a first embodiment;

FIG. 3 is a side elevation of the vacuum condenser of FIG. 2;

FIG. 4 is a plan view of the vacuum condenser of FIG. 2;

FIG. 5 is a cross-section view of the vacuum condenser of FIG. 2 through the section line A-A shown in FIG. 4;

FIG. 6 is a further cross-section view as per FIG. 5 with fluid flow lines indicated;

FIG. 7 is a graph of the temperature and pressure results from testing of the embodiment of FIG. 2;

FIG. 8 is a cross-sectional view of a vacuum condenser according to a second embodiment;

FIG. 9 is a cross-section view of the vacuum condenser of FIG. 8;

FIG. 10 is a partial isometric view of a mulit-nozzle configuration of a vacuum condenser according to a third embodiment;

FIG. 11 is a cross-sectional view of a vacuum condenser utilizing the mulit-nozzle configuration of FIG. 10;

FIG. 12 is a diagrammatic representation of a first vapor absorption system in wherein the vacuum condenser according to the present invention is used for high power applications;

FIG. 13 is a diagrammatic representation of a second vapor absorption system incorporating an adaptation to the system of FIG. 12;

FIG. 14 is a diagrammatic representation of a third vapor absorption system incorporating a further adaptation to the system of FIG. 12; and

FIG. 15 is a diagrammatic representation of a fourth vapor absorption system comprising a pair of the vapor absorption systems of FIG. 14 cascaded together.

### DETAILED DESCRIPTION OF PREFERRED EMBODIMENTS

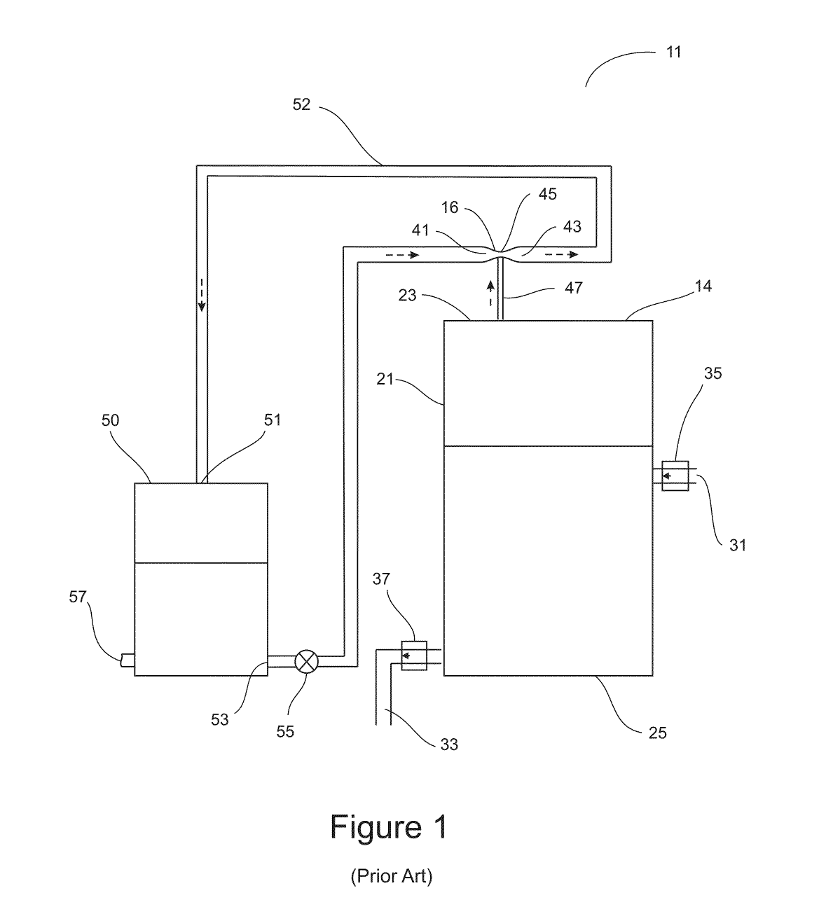

It is helpful to provide a brief description of a vapor absorption system (hereinafter referred to as VAS) as disclosed in WO2011/123904. FIG. 1 is a diagrammatic representation of such a system.

Distillation systems according to the disclosure can be used to distil many different liquid mixtures. A mixture of water with other substances is often distilled and is suitable for distillation by the systems. In this specification, references are made to the use of water in relation to both secondary liquid, which is a mixture and the primary liquid, which in certain, but not all, applications is intended to be relatively pure. Such references are to be taken as exemplary and are not intended to limit the systems described for use with other liquids.

The distillation system 11 according to the first embodiment of the disclosure comprises an evacuation chamber 14 adapted to receive a quantity of liquid (secondary liquid) to be distilled, for example a water mixture. The evacuation chamber 14 is provided with an inlet 31 and a drain or outlet 33. A vacuum condenser 16 is arranged to extract vapor from the upper portion of the chamber 14. The vacuum condenser 16 comprises a venturi inlet 41, a venturi outlet 43 and a narrowed venturi throat section 45 intermediate the venturi inlet 41 and the venturi outlet 43. A port 47 connects the low pressure venturi throat section 45 of the vacuum condenser 16 with the evacuation chamber 14.

In operation, the vacuum condenser 16 evacuates the evacuation chamber to a pressure below that of the vapor pressure of the secondary water in the evacuation chamber 14. Such vapor condenses almost immediately upon entering the water stream, the primary liquid in this case, flowing through the venturi throat section 45. The first embodiment is therefore provided with a receiving tank 50 having a tank inlet 51 connected by piping 52 to the venturi outlet 43. A recirculation outlet 53 is provided proximate the base of the receiving tank 50 which supplies primary water (purified water) to a recirculation pump 55 which pumps primary water to the venturi pump 40. The recirculation pump 55 is selected to be of the size and type suitable to feed the venturi pump 40 at the required pressure and flow rate. A water take off port 57 is provided either as a separate outlet from the receiving tank 50 or as a port from the piping 52 or otherwise to withdraw water from the receiving tank 50 for use. The rate of withdrawal is controlled to prevent the receiving tank from being emptied.

In operation, it can be seen that water is pumped from the receiving tank 50 by the recirculation pump 55 to the venturi pump 16 and then returned to the receiving tank 50. In the process, water is received into the stream from the water vapor extracted from the evacuation tank 14. It is to be appreciated that an apparatus according to the first embodiment has removed the need for a conventional condenser system within the distillation system.

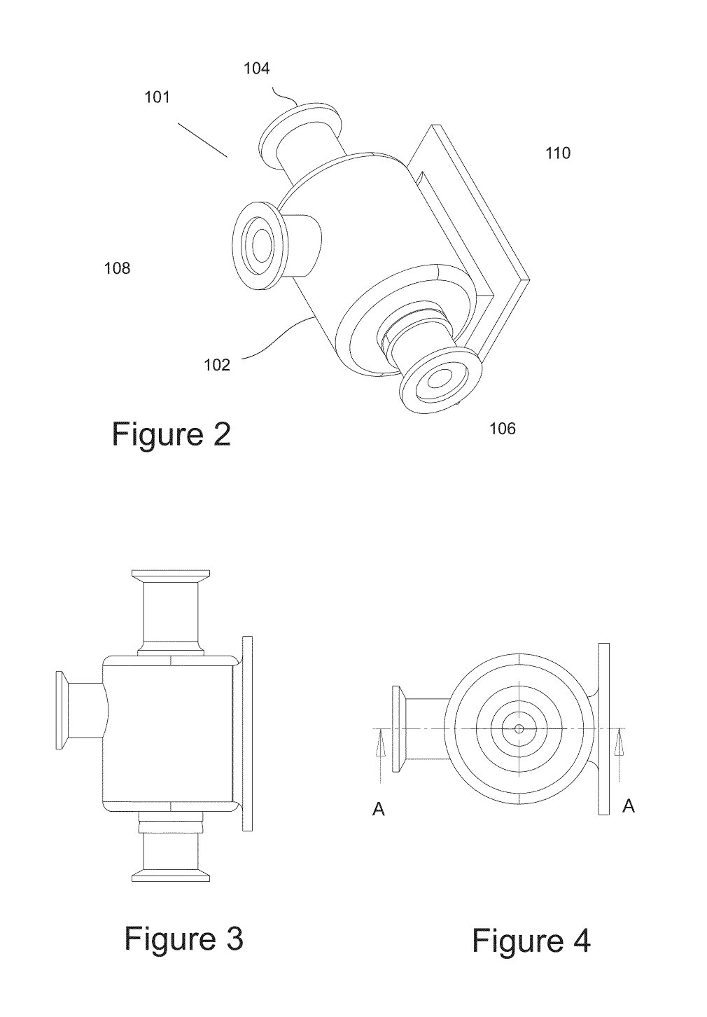

A second embodiment of the vapor absorption system of WO2011/123904 as shown in FIG. 2 of that specification added a heat exchanger 60 into the secondary water to enable heat to be transferred to the secondary water from in a more flexible mariner than in the case of the heat exchanger.

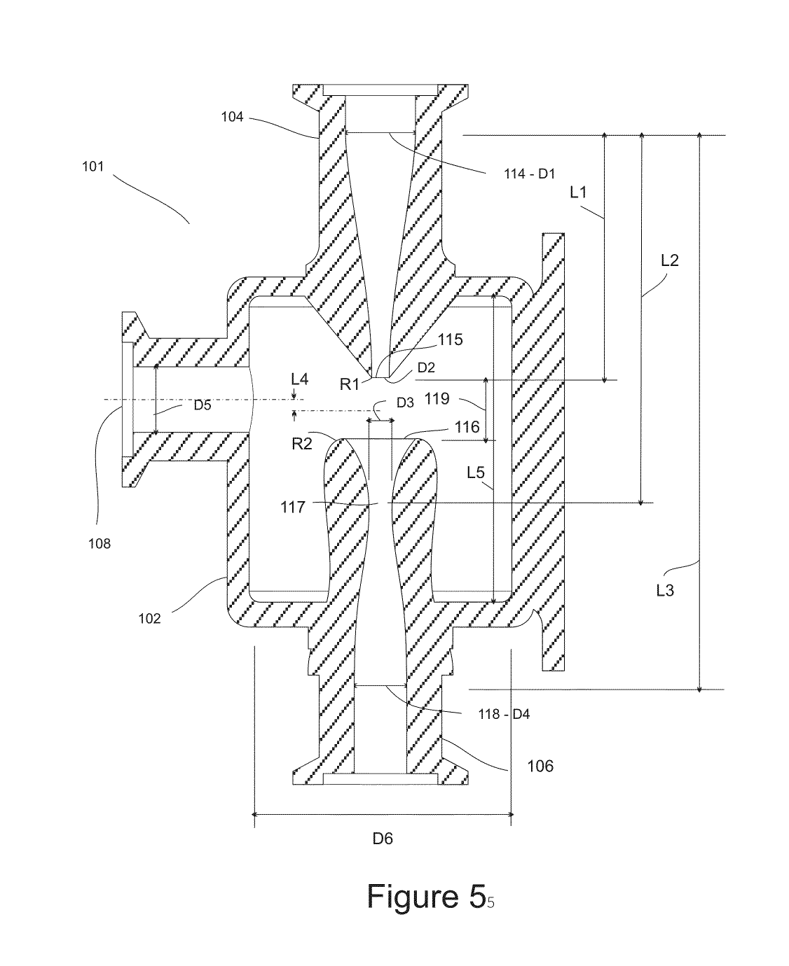

A fifth embodiment of the vapor absorption system of WO2011/123904 as shown in FIG. 5 of that specification provided means for extracting heat from the primary flow for re-use and lowering the primary flow back to its desired input temperature.

The disclosure WO2011/123904 made it clear that it was desirable to use a vacuum condenser of optimum efficiency but until now it has not been appreciated what was necessary to provide such a device. This is because those skilled in the art are not familiar with this application of a venturi vacuum for the purpose of absorbing substantial quantities of vapor. The object of the vapor absorption system is to cause as much as possible of the secondary liquid to be vaporized and then condensed with maximum efficiency. It is noted within the disclosure WO2011/123904 that to cause the secondary liquid to change phase to vapor, energy must be input into the secondary liquid to provide the latent heat of vaporization. Various proposals are given for the ways to provide this energy, other than by using primary or high grade (and therefore expensive) heat sources, otherwise referred to as low grade heat sources. Use of low grade heat sources has the potential advantages not only of lower expense but also more environmentally friendly solutions. However, low grade heat sources are generally available only at temperatures well below 100° C. It is to be noted that the latent heat energy required for vaporization remains almost constant relative to the operating temperature of the secondary liquid. The small difference that does exist is insignificant for the purposes of this invention and may be ignored.

Physically, the amount of vapor processed is limited firstly by the amount of energy that is available for vaporization of the secondary liquid. This limitation becomes particularly important where the quantity of vapor being processed is relatively large. The availability of the heat energy and the means for transferring it to the secondary liquid then become vital design consideration of a VAS. It is noted that the amount of heat available depends both upon the capability of the heat source to provide the heat energy and also the capability to transfer this energy to the secondary liquid, that is, the capability of the heat exchanger. In a normal commercial development of the system, the engineering selection of the heat exchanger is therefore a critical limitation on the potential performance of a particular system.

The next feature of importance is the ability of the vapor condenser to process the vapor that is produced. It has been found that there is a difference between the ability of a vapor condenser to process vapor and the maximum vacuum (minimum pressure) that it is capable of pulling. This is the aspect that has not been considered previously by the prior art. The most effective vacuum condenser will not necessarily pull the maximum vacuum. The operational requirements are subtly different. Pulling the maximum vacuum requires that device continues to effectively scavenge gas molecules when the operational pressure becomes very low. In contrast, a vacuum condenser is concerned with absorbing the maximum volume of gas that it can do without concern for what the operational pressure happens to be. In doing so it sets up a flow of the vapor within the vacuum condenser and it is the cooperation between the vapor flow and the primary liquid flow that leads to effective absorption. This is discussed in some detail below.

It is also to be noted that the temperature of the primary liquid is also of importance. The temperature of the primary liquid should be cold in order to promote condensation of the vapor which is hot. The temperature difference Δt is a primary quantity for condensing. Whether the hot vapor is entrained as vapor or condensed right away (reality it is a complex continuum between these two mechanisms) the temperature rise of the primary liquid flow from entering the vacuum condenser to its exit value when checked matches the thermal power input by the heat exchanger which indicates after a certain length vast majority of all vapor is condensed (phase change back to fluid releases heat that raises the water temperature).

It is also important to appreciate the interrelationship between the effectiveness of the vapor absorption system and the temperature and pressure within the evacuation chamber. Any venturi nozzle creates a vacuum, enables boiling and vapor to be created at a relatively low temperature, but not all venturi nozzles can continuously operate at and maintain relatively low temperature with the application of a predetermined applied high power. Because a certain high power creates a vapor and the density of the vapor is 1000:1 compared with the liquid, the pressure tends to be increase again because of the vapor and the increase in pressure is accompanied by an increase in temperature. The advantage of the present invention is that there is provided a vacuum condenser which can process all of the vapor continuously for a predetermined power input and remain at a relatively low temperature. Other venturi nozzles will cause the temperature to fall if you run a liquid through it because of Bernoulli's law as it creates a vacuum or low pressure. But when significant power is applied to the secondary liquid the vapor absorbed into the cold stream effectively. Venturi vacuum pumps which are not designed in accordance with the present invention will permit the temperature and pressure to rise excessively when the predetermined amount of power is applied. This is of vital importance for many applications of the VAS. A vacuum condenser for a VAS according to the present invention operating at a substantial power input level and therefore processing a substantial quantity of vapor will operate at a steady state at a lower temperature compared any alternative geometry.

The benefit is achieved by a vacuum condenser according to the invention where the shape of the vapor flow within the vacuum condenser is caused to be compatible with the flow of the primary liquid through the venturi throat region. This is effected by configuring various parameters of the vacuum condenser to optimize the vapor flow relative to the primary liquid flow as indicated by reduced or minimized operating temperature for a predetermined input power for vaporization of the secondary liquid.

The first embodiment of the invention is described with reference to FIGS. 2 to 6. The embodiment is directed primarily to the distillation of a water mixture as the secondary liquid, using water as the primary liquid. As shown in these Figures, the first embodiment discloses a vacuum condenser 101 having an enclosed body 102 of generally cylindrical configuration providing a chamber 103. The body 102 supports a nozzle inlet 104 having a nozzle entrance 114 with diameter D1, a nozzle outlet 106 having a nozzle outlet exit 118 of diameter D4 and hot vapor entrance 108 having an entrance diameter D5. Optionally, the body is provided with a support base 110.

The nozzle inlet 104 and nozzle outlet 106 are supported co-aligned by the body 102 to provide a venturi flow path with the nozzle inlet 104 also have and nozzle inlet exit 115 of diameter D2 and the nozzle outlet 106 having a nozzle outlet entrance 116. In the embodiment, the nozzle inlet 104 and the nozzle outlet 106 are formed integrally with the body 102 but in other adaptations, they may be formed separately and assembled to the body. The nozzle inlet 104 provides a reducing flow path from the nozzle inlet entrance 114 to the nozzle inlet outlet 115 to provide flow acceleration and reduced pressure at the nozzle inlet exit 115 into the chamber 103. The reducing flow path has a length L1. The nozzle outlet 106 provides a nozzle outlet entrance 116 to the flow path through it which reduces initially to a nozzle outlet minimum 117 point with a cross-section of diameter D3. The nozzle inlet exit 115 and the nozzle outlet entrance 116 are disposed apart to provide a gap 119 across the chamber 103. However, it is the distance L2 between the nozzle inlet exit 115 and the nozzle outlet minimum 117 which is functionally of particular significance. In operation, primary liquid is passed through the nozzle inlet 104 to the nozzle inlet exit 115 and is then propelled across the gap 119 and enters the nozzle outlet 106 at the nozzle outlet entrance 116. The flow path of the nozzle outlet reduces between the nozzle outlet entrance 116 and the nozzle outlet minimum 117 to enable the nozzle outlet to receive the primary liquid flowing across the gap 119 without introducing flow separation or significant turbulence. The nozzle outlet 106 expands from the nozzle outlet minimum 117 to the nozzle outlet exit 118 to complete the venturi formation. The distance from the commencement of the reducing flow path of the nozzle inlet 104 at the nozzle inlet entrance 114 to point where the nozzle outlet 106 ceases expanding at the nozzle outlet exit 118 is L3.

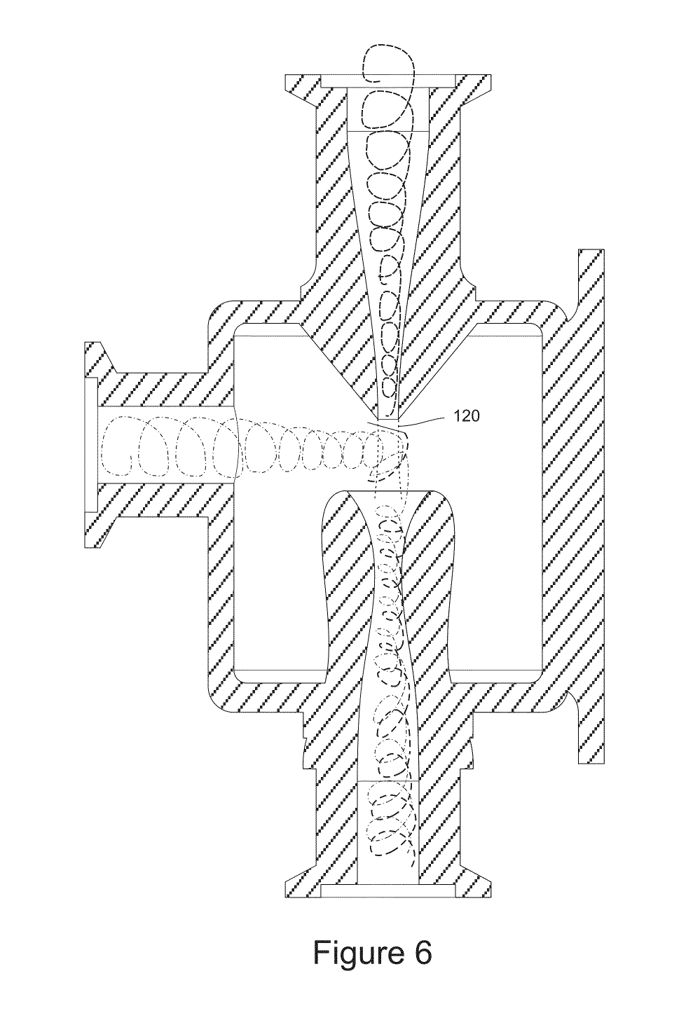

The reduced pressure within the chamber 103 causes vapor to be drawn from the enclosure holding the secondary liquid (not shown) through the hot vapor entrance 108. The hot vapor entrance 108 is positioned to direct vapor flow towards the gap 119 curving in a generally helical mariner, as shown in FIG. 6 and testing has been undertaken using various offsets, L4 of the axis of the hot vapor entrance 108 from the centre of the gap 119. The vapor is influenced by the flow of the primary liquid through the gap in a mariner that promotes absorption of the vapor.

The embodiment as described above has been derived from previously tested venturi nozzles and is modified to promote vapor absorption. Importantly, the enclosed body 102 provides a controllable space for vapor flow whereby the shape and flow stream of the vapor are formed to provide compatibility with the primary flow, as is represented in FIG. 6. The provision of the gap 119 has been found to be particularly advantageous to the performance of the vacuum condenser and it is understood that this is because it provides the flow of primary liquid with additional time and ready access to the vapor. The primary liquid flow in the gap 119 substantially forms a cylindrical segment 120 as shown in FIG. 6 having a diameter of approximately D₂ and functional length somewhat longer than the length of the gap Lg. The surface area available for absorption of vapor is therefore calculated according to the equation

A=πD L_{g}

This calculation suggests that any increase to this length should be beneficial but testing has revealed that there is an optimum length for L_{g}. For example if Lg is so long that the impinging hot vapor flow misses part of the quasi-cylindrical jet flow, the benefit of the additional length that is missed is likely minimal or negligible.

It has been observed that there is a small but discernable improvement if the vacuum condenser 102 is oriented so that the flow of primary liquid is vertically downwards and it believed that this is due to the effect of gravity.

During testing some 11 physical parameters of the vacuum condenser have been identified and varied to investigate their effects on the performance of the vacuum condenser 102 in absorbing vapor. A table, Table 1, shown below, tabulates the information and ranks the effect of the each parameter in respect of various performance factors of the vacuum condenser. The table describes qualitatively for each their general characteristic and their effect on water pressure drop, water vapor entrainment, water vapor condensation, pumping power and mass flow of the driving fluid. A value of 3 means a strong effect, 2 means a moderate effect and 1 means a lesser effect.

In determining an optimum design, the first step is to identify the power input Pᵢₙ that is applied to the secondary liquid. As previously discussed, this power determines vapor production rate. In conducting these tests a power of 10 kW was selected such that VAS would produce ˜100 gallons per day.

The next step is to specify a primary liquid flow that will be compatible with the vapor flow being produced. Vapor absorption (entrainment/condensation) is a complicated process based upon multiple factors, but asymptotically approaches the vapor production. The important point of all the other factors is that they contribute to the temperature at which vapor production and absorption are equal (steady state operation). The embodiment is adapted to achieve the lowest steady state temperature inside the vacuum chamber given a specific power input. Once D1, D2, D3, D4, D5, L1, L2, L3, L4, L5 have been selected from a test report where D1 and D2 primary, i.e., they apply to Bernoulli's equation for a given flow rate the difference in diameter from large (D1) to small (D2) leads to the pressure reduction at D2 that provides the vacuum to the vacuum chamber. However, if the flow rate is too low, the nozzle jet flow that ‘jumps’ across the gap 119, will not be established. That is if the flow is too slow, the nozzle and exit chambers with the jet in between do not ‘seal’ fully. For the baseline D1=16 mm, experimentally we see that the flow rate needs to be at least 13.3 litres/minute or more to get a proper seal and pumping/vacuum effect takes place.

The flow rate can be increased from this minimum rate to a higher value which results in a higher pressure drop and the volumetric flow rate multiplied by the pressure drop represents the mechanical power required to drive the vacuum pump. Studies show that there is small vapor absorption benefit to higher flow rates, but the extra ‘cost’ to required mechanical power has resulted in a design practice to set flow rate by determining the minimum rate that establishes the pump/vacuum and then increase this value so that it is safely and consistently establishes and maintains the pumping/vacuum effect. Specifically, a flow rate of approximately 16 litres per minute is preferred.

As mentioned, Table 1 identifies other parameters that may be varied.

TABLE 1
Table 1

| | Ejector | | | | | | | | |
|---|---|---|---|---|---|---|---|---|---|
| | Critical | | Pressure | | | Pumping | Mass | Values | |
| No. | Dimensions | Characteristic | Drop | Entrainment | Condensation | Power | Flow | Tested | |
| 1. | D₁ = Nozzle | Must be large | 1 | 1 | 1 | 3 | 3 | 16 | mm |
| | Inlet Entrance | to reduce inlet | | | | | | | |
| | Diameter | losses | | | | | | | |
| 2. | D₂ = Nozzle | Critical to | 3 | 3 | 1 | 3 | 3 | 4 | mm |
| | Inlet Exit | pumping | | | | | | | |
| | Diameter | power and | | | | | | | |
| | | water vapor | | | | | | | |
| | | entrainment | | | | | | | |
| 3. | D₃ = Nozzle | Critical to | 1 | 3 | 2 | 1 | 1 | 5.25-6 | mm |
| | Outlet | water vapor | | | | | | | |
| | Minimum | entrainment | | | | | | | |
| | Diameter | | | | | | | | |
| 4. | D₄ = Nozzle | Critical to | 1 | 2 | 3 | 1 | 1 | 11.1-12 | mm |
| | Outlet Exit | keep water | | | | | | | |
| | Diameter | flow from | | | | | | | |
| | | separating | | | | | | | |
| 5. | D₅ = Hot | Must be large | 1 | 3 | 1 | 1 | 1 | 12-26 | mm |
| | Vapor | not to restrict | | | | | | | |
| | Entrance | water vapor | | | | | | | |
| | Diameter | flow | | | | | | | |
| 6. | D₆ = Body | Critical for | 1 | 3 | 3 | 1 | 1 | 20-80 | mm |
| | internal | vapor | | | | | | | |
| | diameter | entrainment | | | | | | | |
| 7. | L₁ = Length | Must be | 1 | 1 | 1 | 2 | 1 | 40-92 | mm |
| | between D1 | optimized to | | | | | | | |
| | and D2 | reduce inlet | | | | | | | |
| | | loss | | | | | | | |
| 8. | L₂ = Length | Is the vapor | 1 | 3 | 1 | 1 | 1 | 60-112 | mm |
| | between D1 | entrainment | | | | | | | |
| | and D3 | zone | | | | | | | |
| 9. | L₃ = Length | Control | 1 | 2 | 3 | 1 | 1 | 140-170 | mm |
| | between D1 | if flow | | | | | | | |
| | and D4 | separates | | | | | | | |
| 10. | L₄ = Offset of | Critical to | 2 | 3 | 3 | 1 | 1 | 3-38 | mm |
| | vapor inlet | lower Tsat, | | | | | | | |
| | axis from | Psat | | | | | | | |
| | center gap | | | | | | | | |
| 11. | L₅ = Body | Critical | 1 | 3 | 3 | 1 | 1 | 10-70 | mm |
| | internal | for vapor | | | | | | | |
| | length | entrainment | | | | | | | |

| | | | | | | | | |
|---|---|---|---|---|---|---|---|---|
| 12. | Radius | Critical to | 1 | 3 | 1 | 2 | 1 | K1-5 mm |
| | Leading | smooth vapor | | | | | | 000-anti-splash |
| | Edge | entrainment | | | | | | |
| 13. | Radius | Critical | 1 | 3 | 2 | 2 | 1 | K1-.5 mm |
| | Trailing | to vapor | | | | | | 000-sharp |
| | Edge | entrainment | | | | | | |
| 14. | Radius | Critical | 1 | 3 | 2 | 2 | 1 | K1-.5 mm |
| | Trailing | to vapor | | | | | | 000-sharp |
| | Edge | entrainment | | | | | | |

During testing, the various design parameters of the vacuum condenser are repetitively modified and the modified vacuum condenser is tested using the application of the pre-determined power level to the secondary liquid within the enclosure to ascertain whether the temperature and pressure of the modified vacuum condenser are at a minimum relative to previous designs tested. This process provides method of optimizing the performance of the vapor condenser whereby the optimum performance is assessed relative to the temperature and pressure of the saturated vapor during stable operation, and parameters providing the minimum temperature and pressure are selected.

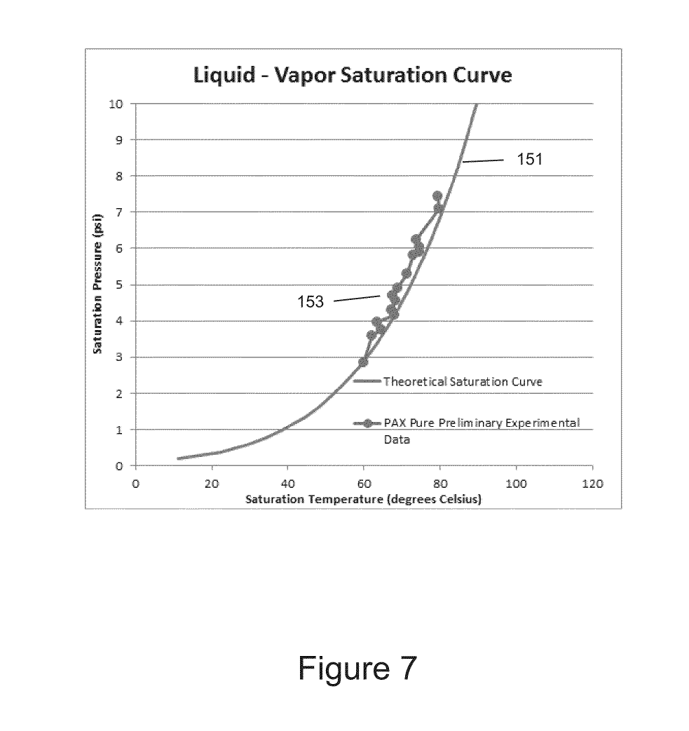

The results of the testing have been plotted on the graph shown in FIG. 7. The graph of FIG. 7 includes a continuous line 151 indicating the theoretical saturation curve from calculations, and points plotted on the graph which were the results of experimental testing.

TABLE 2
Theoretical Saturation Curve

| Pressure | BP for Water | Pressure |
|---|---|---|
| [torr] | [deg C.] | [psi] |
| 10 | 11.3 | 0.19337 |
| 20 | 22.2 | 0.38674 |
| 30 | 29.0 | 0.58011 |
| 40 | 34.1 | 0.77348 |
| 50 | 38.2 | 0.96685 |
| 60 | 41.6 | 1.16022 |
| 70 | 44.5 | 1.35359 |
| 80 | 47.1 | 1.54696 |
| 90 | 49.5 | 1.74033 |
| 100 | 51.6 | 1.9337 |
| 125 | 56.2 | 2.417125 |
| 150 | 60.1 | 2.90055 |
| 175 | 63.5 | 3.383975 |
| 200 | 66.5 | 3.8674 |
| 225 | 69.2 | 4.350825 |
| 250 | 71.6 | 4.83425 |
| 275 | 73.9 | 5.317675 |
| 300 | 75.9 | 5.8011 |
| 325 | 77.9 | 6.284525 |
| 350 | 79.7 | 6.76795 |
| 375 | 81.4 | 7.251375 |
| 400 | 83.0 | 7.7348 |
| 425 | 84.5 | 8.218225 |
| 450 | 86.0 | 8.70165 |
| 475 | 87.4 | 9.185075 |
| 500 | 88.7 | 9.6685 |
| 525 | 90.0 | 10.15193 |
| 550 | 91.2 | 10.63535 |
| 575 | 92.4 | 11.11878 |
| 600 | 93.5 | 11.6022 |
| 625 | 94.6 | 12.08563 |
| 650 | 95.7 | 12.56905 |
| 675 | 96.7 | 13.05248 |
| 700 | 97.7 | 13.5359 |
| 725 | 98.7 | 14.01933 |
| 750 | 99.6 | 14.50275 |
| 760 | 100.0 | 14.69612 |

TABLE 3
Preliminary Experimental Data

| | Temp | Pressure |
|---|---|---|
| | [deg C.] | [psi] |
| 1 | 79.5 | 7.45 |
| 2 | 79.6 | 7.1 |
| 3 | 73.9 | 6.25 |
| 4 | 74.6 | 6.05 |
| 5 | 74.6 | 5.9 |
| 6 | 73 | 5.8 |
| 7 | 71.3 | 5.3 |
| 8 | 69 | 4.9 |
| 9 | 67.5 | 4.7 |
| 10 | 68.3 | 4.55 |
| 11 | 67.3 | 4.3 |
| 12 | 68 | 4.15 |
| 13 | 63.5 | 3.95 |
| 14 | 64.5 | 3.75 |
| 15 | 62.2 | 3.6 |
| 16 | 60 | 2.85 |

It can be seen from these tables and this graph that the method has been successful at providing a vacuum condenser which can operate a temperature of 60° C. whereas before optimization method was commenced a temperature of 80° C. was being produced.

it is important to note that the key factor for the VAS to condense the vapor from vacuum chamber (shell side of the heat exchanger) is the fact that the exposed jet of water to the vapor has a temperature lower than the vapor. The condensation process is primarily driven by this delta temperature not the specific temperatures on the cold side and the vapor side.

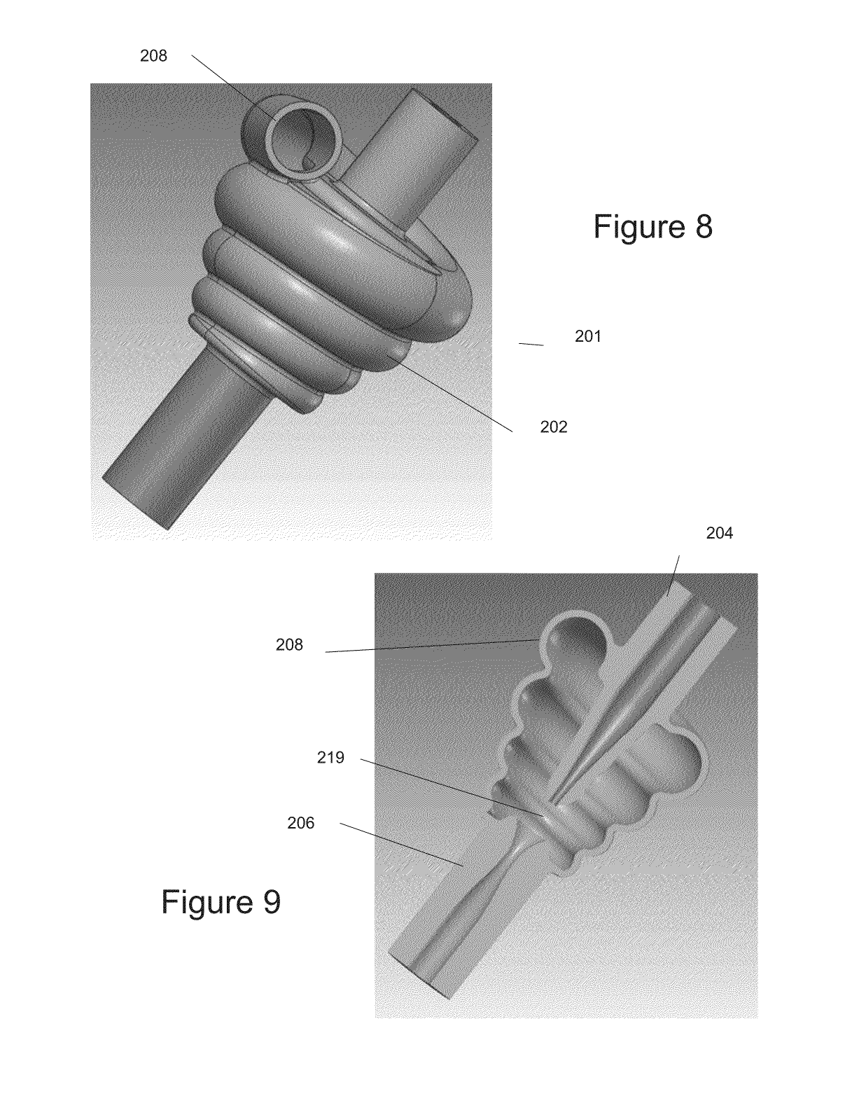

A second embodiment of the invention is described with reference to FIGS. 8 and 9. The second embodiment is functionally similar to the first embodiment but is visually very distinctive from the first embodiment. The vacuum condenser 201 of the second embodiment comprises an enclosed body 202, an inlet nozzle 204, an outlet nozzle 206 and a hot vapor entrance 208. The principal difference of the second embodiment is that the body 202 is not cylindrical but has a spiro-conical appearance with the hot vapor entrance being located at one end of the body 202 proximate the inlet nozzle entrance. The spiro-conical formations of the body provide a spiro-helical pathway to urge the hot vapor into a vortical type of fluid flow. This fluid flow appears to assist vapor flow at the gap 219 between the inlet nozzle and the outlet nozzle to co-operate with the flow of the primary liquid and promote vapor absorption.

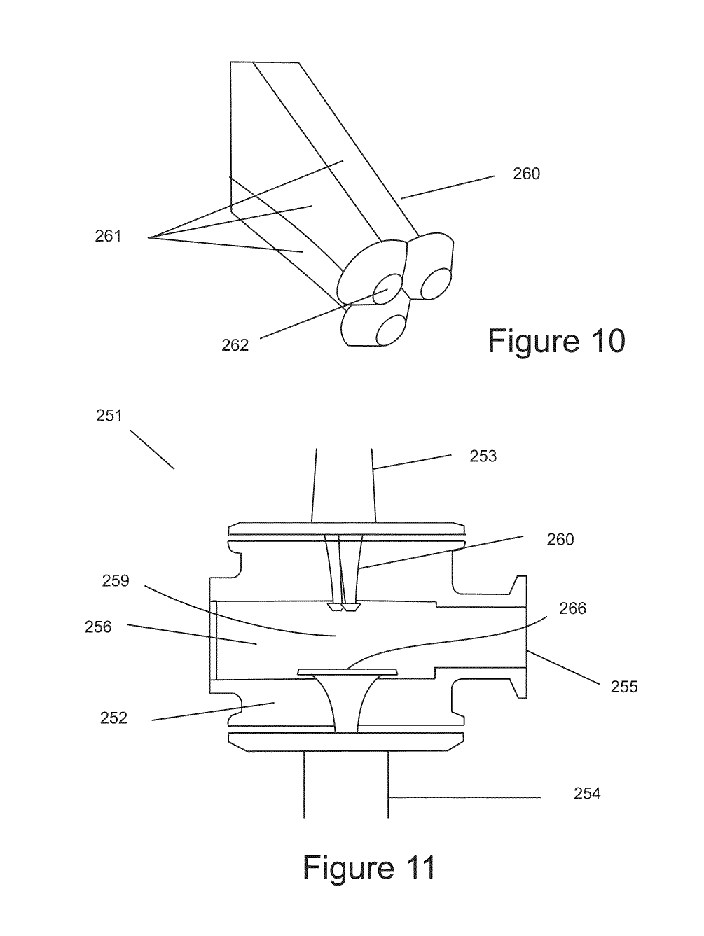

A third embodiment of the invention is described with reference to FIGS. 10 and 11. The third embodiment provides a vacuum condenser 251 having a group of a plurality of jets 261, in this case 3 being shown, forming the inlet nozzle 260 of the vacuum condenser 251 and having outlet orifices 262. The vacuum condenser 251 has a body 252 providing a chamber 256 and comprises an inlet 253, an outlet 254, a hot vapor entrance 255 and a nozzle outlet entrance 266 performing the functions as described with respect to the first embodiment. The jets 261 are configured and aligned with the body 252 to direct primary water flow across the gap 259 to the nozzle outlet entrance 266.

In certain configurations and operating ranges, the provision of multiple jets according to this embodiment provides improved performance over the configuration of a single jet of the first embodiment. However, this outcome is not universal, as in certain configurations and operating ranges, the performance is substantially the same as for a single jet. Minor changes to the shape of the outlet orifices 262 from circular do not appear to impact the performance of the jets 261.

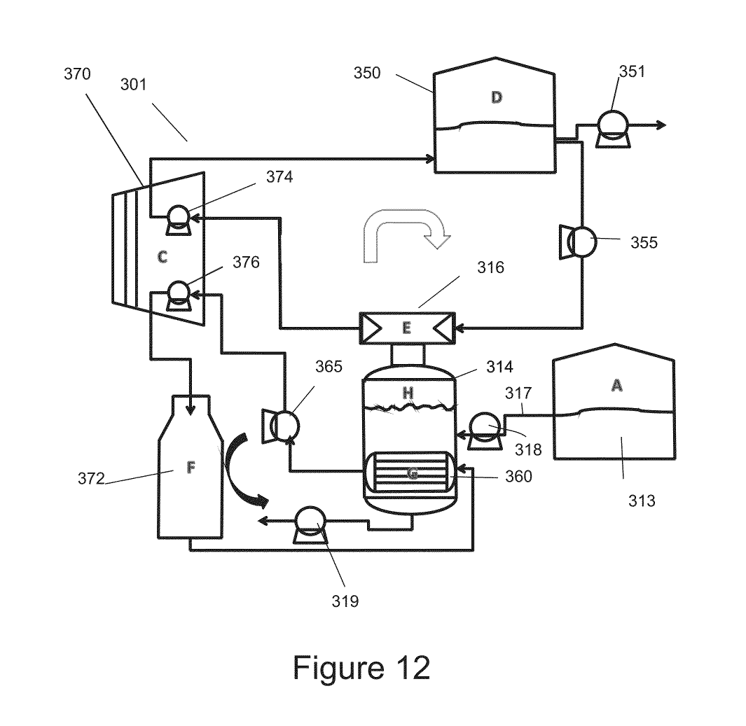

The present invention is directed to enabling the VAS of WO2011/123904 to be applied to high power, commercial operations. For this, inventive developments have been applied to the features of the VAS as described in WO2011/123904 to provide a more sophisticated system capable of supplying distilled product on a continuous basis and achieving specific operating goals. A first vapor absorption system is described with reference to FIG. 12.

The VAS 311 of FIG. 12 comprises an evacuation chamber 314 adapted to receive and process secondary water (produced or dirty water) received from a storage 313 by duct 317 and assisted and controlled by pump 318. The evacuation chamber 314 is provided with a heat exchanger 360 to supply .latent heat of vaporization to the secondary water and a purging pump 319. The heat exchange fluid is circulated by heat exchange pump 365. The heat exchange fluid which has passed through the heat exchanger 360 communicates with a secondary water heat exchange circuit 376 within a heat pump 370, the purpose of which is discussed below.

An evacuation pump in the form of a vacuum condenser 316 according to the present invention is in communication with the evacuation chamber 314 and is adapted to receive water vapor from the evacuation chamber 314. The vacuum condenser 316 receives primary water under pressure from a primary water store 350 which has associated with a controlled removal pump 351. The primary water is pressurized by pump 355, the primary water being forced through the vacuum condenser to .generate reduced pressure in the evacuation chamber 314 as discussed further within the description thereby absorbing vapor from the evacuation chamber 314. Water exiting the vacuum condenser 316 comprises a primary water mixture being a mixture of the primary water and the absorbed and thereby condensed vapor from the evacuation chamber 314. As has been discussed the temperature of this primary water mixture has been raised relative to the incoming primary water due to the release of latent heat when the vapor condenses. The primary water mixture is transferred to a primary water circuit 374 of the heat pump 370 at which at least a portion of the latent heat is released to the heat exchange fluid within the heat exchange fluid circuit 376, thereby cooling the primary water mixture and returning heat energy for use in the heat exchange cycle.

From the heat pump 370 the heat exchange fluid is passed to a heat source 372 in the form of a water heater or boiler. The heat source provides additional heat energy to the heat exchange fluid to raise the temperature to that required to vaporize the secondary water. Where a suitable low grade heat source is available, this may be used instead. The cooled primary water mixture is returned to the primary water store 350. Water added to the primary water from absorption of the vapor can be drawn off from the primary water store 350 for alternative use.

The VAS can be run as a batch or continuous system. In order to make the system continuous, the produced water level is monitored in the heat exchanger shell and refilled using a vacuum compatible pump (i.e. peristaltic). When the concentrate left in the heat exchanger shell reaches the desired maximum concentration, the vapor absorption process is briefly halted, using electrically controlled valves, and the concentrate is drained. Then the valves close, the pump refills the heat exchanger shell with more produced water, and production continues.

It can be seen that an advantage of the system is that the primary liquid is kept isolated from the secondary liquid to prevent contamination of the primary liquid by the secondary liquid.

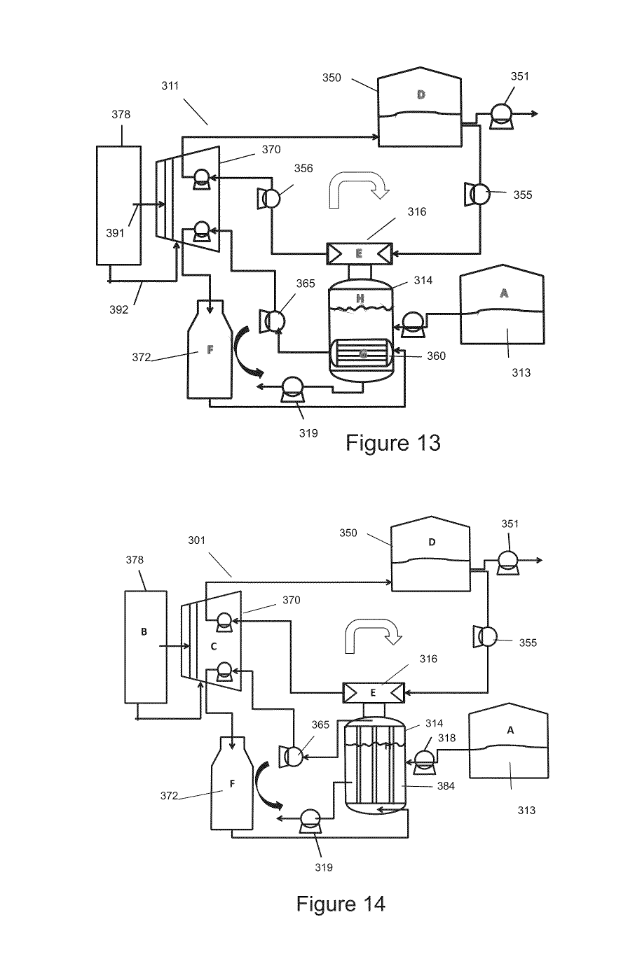

FIG. 13 illustrates a second vapor absorption system which is a minor adaptation of the system of FIG. 12. In FIG. 13, like numerals are used to depict parts alike to those in FIG. 12. It has been found advantageous in certain applications to provide a second pump 356 in the primary water flow, the pump 356 being located on the outlet side of vacuum condenser. It is believed that this facilitates flow across the gap 119 and in particular the reception of the primary water and vapor into the nozzle at the nozzle outlet entrance 116 and nozzle outlet minimum 117.

As well, the second vapor absorption system includes an adaptation of the system as shown in FIG. 12, in that a gas ‘turbine’ or gas generator is provided. The gas ‘turbine’ drives a generator to generate electricity so that the heat pump 370 can be electrically operated. The lines 391 and 392 between the gas turbine 378 and the heat pump 370 indicate that hot air exhaust can be reused as well as receive electrical power. If the chiller/heat pump runs directly off gas, B's requirement to provide electric power would be greatly reduced. However the COP for gas fired chiller/heat pumps are NOT as high as electric ones.

A third arrangement of a vapor absorption system is shown in FIG. 14. Again, this third vapor absorption system is an adaptation of the arrangement of the first vapor absorption system shown in FIG. 12, and so like numerals are used to depict like parts. In this third arrangement, the system has been modified such that a tube shell heat exchanger 384 on the shell side is actually the vacuum condenser. As a result, the evacuation chamber and the heat exchanger are integrated such that one component is eliminated. In s preferred adaptation the tube shell comprises a shelf titanium tube bundle with plastic shell enclosure.

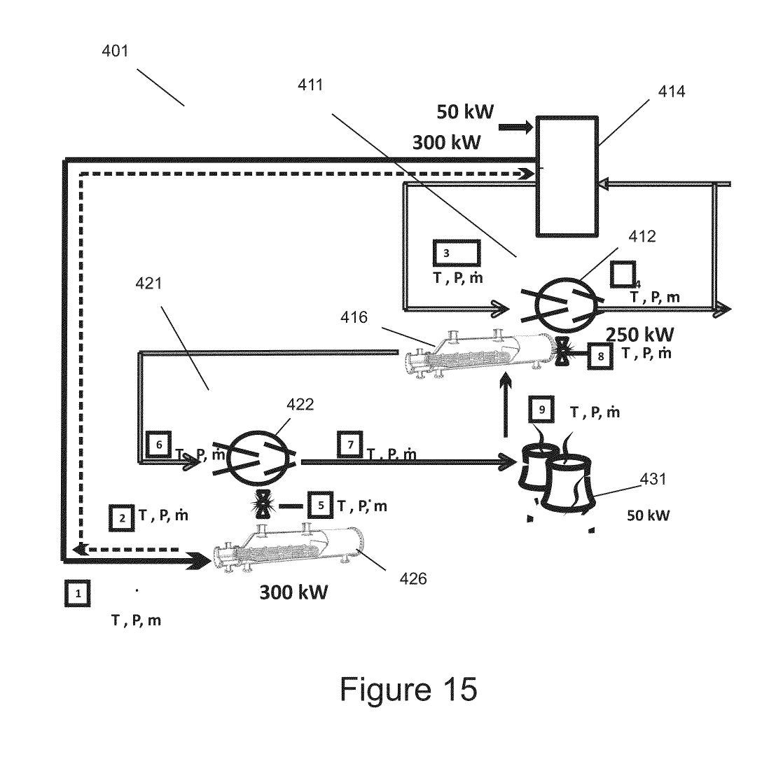

The VAS according to the arrangements of FIGS. 12 to 14 is may be adapted to enable thermal energy recovery using stages, i.e., cascading one VAS into another. Since the VAS operates at low temperatures, coupling a multi-stage VAS with a modern ‘off the shelf’ Chiller (heat pump) can provide a Co-efficient of Performance (COP) in the order of 10. FIG. 15 provides an example of a cascade VAS system 401 comprising two VAS systems 411 and 421 of the type described in relation to FIG. 14, having vacuum condensers 412 and 422, tube shell heat exchangers 416 and 426 and chiller 414 coupled together with a cooling tower/water preheat 431 being a cooling tower and water preheater.to provide a cascade pair of VAS systems.

It has been noted earlier that the key factor for the VAS to condense the vapor from vacuum chamber (shell side of the heat exchanger) is the fact that the exposed jet of water to the vapor has a temperature lower than the vapor. The condensation process is primarily driven by this temperature difference (the delta temperature) not the specific temperatures on the cold side and the vapor side. Also, it is known that modern Chillers (Heat Pumps) have normal operating specifications for their source water IN to be around 14 deg C. From this water, energy is extracted due to interaction with its own refrigerant loop driven by electric scroll compressors. This excess energy is used to expel hot water at nominal temperatures around 45 deg C and at the same time expel chilled water at 4 deg C. Using the hot expelled water of 45 deg C as input to the tube side of a tube shell heat exchanger/vacuum condenser (number X of FIG. 14), vapor from the ‘produced (dirty)’ water now has a temperature above 40 degrees C. and will condense on clean water jet within a VAS vacuum condenser 411 that is initially ambient temperature (since ambient temperature is below 40+deg C). As a result the energy due to condensation results in a temperature rise 0of this ambient temperature flow in the range of 10-12 deg C. This elevated ambient temperature flow can be cascaded into another tube side of a second VAS 421 tube/shell heat exchanger/vacuum producing vapor again only this time the vapor is condensed with the 4 deg C flow exiting the chiller 431. This flow then increases to the range of 14 deg C to become again the heat energy source for the chiller 431.

In order for the cascade to work, the “cold loop” on the first system 411 needs to be at a high enough temperature that the second system 421 can process all of the recovered heat from system with 411 with the second system 421's cold loop at ambient temperature.

As a result of the two stage or single cascade effect of coupling two VAS systems together in combination with a modern chiller, COPs of the order of 10 are possible when the COP for the chiller alone is approximately 5 and the cascade by itself is approximately 2. In the example an electrical input into the first stage of 50 kW can provide 250 kW of output heat for vaporization at the first stage and then 300 kW at the second stage. It will be recognized that it is possible to cascade further VAS system into a multi-stage arrangement achieving very high thermal recovery. Of course the economics of the cost of modern chillers and the electric power to drive them is a factor to consider with regards to practical pragmatic product implementations.

The VAS using a vacuum condenser according to the present invention as discussed in relation to the embodiments greatly expands the uses for the VAS because the temperature required to provide the latent heat to the secondary liquid is lower than would be provided by conventional venturi vacuum pumps. One potential use is in the field of mining of oil and natural gas. Often the mineral is forced from underground by pumping water into the bore to drive out the mineral. Water returns with the mineral but is usually badly contaminated. It is an environmental requirement that the contaminated water be purified. The VAS is potentially well suited to cleaning this water, but an additional problem is that the contaminated water often is very corrosive and so it must not be permitted to come in contact with many materials, especially those typically used in heat exchangers. When the heat exchanger has to be the device that creates the boiling you have to have another liquid which is benign e.g. glycol water, clean water, is heated up above this operating boiling temperature and runs through heat exchanger and the heat exchanger touches the contaminated water. It is the heat exchanger that brings this device up to the boiling temperature so that vapor can be produced. If device works at 80 instead of 60 degrees then an operating liquid temperature of about 95° C. is needed—almost boiling at atmospheric pressure. It is harder to find waste low grade heat sources that will deliver heat at these higher temperatures. What makes the invention a viable economic device for this process is because the vacuum pump of the embodiment brings down the boiling point to a sufficiently low temp such as 60° C. or even 50° C. such that commercial processes waste heat can be used in the device.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. A vacuum condenser comprising:
an enclosed body comprising:
a chamber receiving a primary liquid and a secondary liquid;
an inlet nozzle supported by the enclosed body and having an inlet nozzle entrance and an inlet nozzle exit, the inlet nozzle:
providing an inlet nozzle flow path for the primary liquid; and
having a reducing cross-section between the inlet nozzle entrance and the inlet nozzle exit;
an outlet nozzle supported by the enclosing body, co-aligned with the inlet nozzle, and having an outlet nozzle entrance, an outlet nozzle exit, and an outlet nozzle minimum region, the outlet nozzle:
providing an outlet nozzle flow path for the primary liquid co-aligned with the inlet nozzle flow path;
having a receiving portion of progressively reducing cross-section between the outlet nozzle entrance and the outlet nozzle minimum region; and
having an expanding portion between the outlet nozzle minimum region and the outlet nozzle exit for providing a venturi profile in a primary flow of the primary liquid, and
a hot vapor entrance supported by the enclosing body that communicates the second liquid as a vapor flow to the chamber,
wherein the secondary liquid within the enclosed body maintains a stable minimum operating temperature for a predetermined substantial rate of production of vapor.

2. A vacuum condenser as claimed in claim 1, wherein the predetermined substantial rate of production of vapor is determined by selecting an energy input level to provide a required latent heat of vaporization to the secondary liquid.

3. (canceled)

4. The vacuum condenser as claimed in claim 1, wherein the inlet nozzle comprises a plurality of jets, each of the plurality of jets having the same flow rate and directing the primary liquid expelled from the jets to the outlet nozzle outlet entrance to be received thereby.

5. The vacuum condenser as claimed in claim 4 wherein the inlet nozzle exit and the outlet nozzle entrance are separated by a gap.

6. The vacuum condenser as claimed in claim 5, wherein the gap has a size selected to cause the secondary liquid within the enclosure to maintain a stable minimum temperature.

7. The vacuum condenser of claim 1 further comprising:
a first pump being provided on a nozzle outlet side of the primary liquid flow path, and
a second pump being provided on a nozzle inlet side of the primary liquid flow path.

8. (canceled)

9. The vapor absorption system comprising an evacuation chamber configured to receive a secondary liquid, the secondary liquid being a mixture to be distilled, the evacuation chamber having:
a space above the secondary liquid configured to receive vapor evaporated from the secondary liquid, and
an evacuation pump associated with the evacuation chamber and adapted in use to provide a reduced pressure within the space to promote vaporization of the secondary liquid, the evacuation pump comprising a vacuum condenser of claim 1 operated by a primary liquid flowing through the vacuum condenser.

10. The vapor absorption system as claimed in claim 9 further comprising:
a heat transfer and recovery system; and
a heat pump having a primary liquid heat exchange circuit and a secondary liquid heat exchange unit,
the heat transfer and recovery system comprising a heat exchanger adapted to supply a heat energy to the secondary liquid to provide a latent heat of vaporization, the heat energy being transferred from a heat exchange fluid passing through the heat exchanger, the heat exchange fluid thereafter being conveyed to the secondary fluid heat exchange circuit
the heat pump receiving the primary liquid from the evacuation pump passing through the primary liquid heat exchange circuit, to transfer the latent heat received by the primary liquid with the evacuation pump to the heat exchange fluid by means of the heat pump,
wherein the heat exchange fluid is re-circulated to the heat exchanger.

11. The vapor absorption system as claimed in claim 10 further comprising a heat replenishment system to provide additional heat to the heat exchange fluid to compensate for heat dissipated within the system.

12. The vapor absorption system as claimed in claim 9, wherein a pump is provided on the outlet side of the evacuation pump.

13. The vapor absorption system as claimed in claim 10, wherein the evacuation pump and the heat exchanger form an integral unit in the form of a tube shell heat exchanger.

14. The vapor absorption system as claimed in claim 9, wherein the primary liquid is kept isolated from the secondary liquid to prevent contamination of the primary liquid by the secondary liquid.

15. The cascade vapor absorption system formed by integrally combining a plurality of the vapor absorption systems according to claim 10, wherein a latent heat output resulting from a condensation of vapor of any one of the vapor absorption systems is supplied to a subsequent unit to provide the latent heat of vaporization for the subsequent unit.

16. the vacuum condenser of claim 5, wherein the hot vapor entrance is positioned to direct the vapor flow towards the gap, the vapor flow curving in a generally helical manner.

17. The vacuum condenser of claim 16, wherein the enclosed body provides a controllable space for the vapor flow that provides a compatibility with the primary flow.

18. The vacuum condenser of claim 17, wherein the primary flow in the gap forms a substantially cylindrical segment having a functional length longer than the gap.

19. The vacuum condenser of claim 1, wherein the primary flow is vertically downwards.

20. The vacuum condenser of claim 1, wherein the enclosed body is cylindrical or spiro-conical.
